(19) United States
(12) Patent Application Publication
(10) Pub. No.: US 2026/0366702 A1
(43) Pub. Date: Nov. 19, 2026

(54) A LENS UNIT

(71) Applicant: SIGNIFY HOLDING B.V., EINDHOVEN (NL)

(72) Inventors: WEIWEI WANG, SHANGHAI (CN); YUN LI, SHANGHAI (CN); YUANJING PENG, SHANGHAI (CN)

(21) Appl. No.: 19/133,765

(22) PCT Filed: Nov. 27, 2023
(86) PCT No.: PCT/EP2023/083118

§ 371 Date: May 29, 2025

(30) Foreign Application Priority Data
Dec. 6, 2022 (WO) PCT/CN2022/136981
Feb. 6, 2023 (EP) 23155014.6

(51) Int. Cl. F21V 13/04; F21V 5/00; F21V 5/04; F21V 5/08; F21V 7/00; F21Y 115/10

(52) U.S. Cl. CPC F21V 13/04; F21V 5/007; F21V 5/043; F21V 5/08; F21V 7/0091; F21Y 2115/10

(57) ABSTRACT

A lens unit for directing light generated by a light source of a luminaire. The lens unit comprises a refraction portion and a total internal reflection portion. The total internal reflection portion is arranged in an L-shape.

### FIELD OF THE INVENTION

The present invention relates to the field of luminaires, and in particular to lens units for use in such luminaires.

### BACKGROUND OF THE INVENTION

The use of luminaires is becoming increasingly common. Such luminaires make use of one or more optical systems or elements for controlling the emission of light output therefrom. A typical form of an optical system is a lens unit, which controls the direction, spread and uniformity of light output by the luminaire.

There are a wide variety of different scenarios in which a luminaire can be used. In some environments and situations, e.g., in outdoor environments, it is only possible to position the luminaire in a corner of an area to be illuminated. There is an ongoing desire to improve the effectiveness of such luminaires.
EP 3483500A1 discloses an optical element, which is used in a lighting fixture.
U.S. Pat. No. 10,330,902B1 discloses an illumination optic being a collimator lens.
EP 2871411A1 discloses an optical element for a lamp and a corresponding lamp.

### SUMMARY OF THE INVENTION

The invention is defined by the claims.

According to examples in accordance with an aspect of the invention, there is provided a lens unit for a luminaire comprising a light source. The lens unit has an axis perpendicular to a plane on which the light source is positioned.

The lens unit comprises: a light source cavity into which the light source is positionable to receive light from the light source; a refraction portion, distanced from the plane, for refracting light received from the light source; and a total internal reflection portion, distanced from the plane, comprising a first sub-section and a second sub-section that are angled with respect to one another so as to form an L-shape when viewed along a direction normal to the plane.

Each of the first sub-section and the second sub-section of the total internal reflection portion comprises a first surface that faces towards the refraction portion and a second surface that faces away from the refraction portion. The second surface is sloped with respect to the plane to reflect light received from the light source using total internal reflection.

The second surface comprises a proximal end and a distal end, the proximal end being positioned closer to the light source cavity than the distal end. In a sectional plane through the axis, a distance between the proximal end and the axis is larger than a distance between the distal end and the axis.

The use of a light source cavity improves a compactness (e.g., reduces a thickness) of a luminaire containing such a lens unit.

The total internal reflection portion is thereby considered to reflect light received from the light source. This facilitates the directing of light towards a general direction away from the total internal reflection portion, to provide a brighter and more uniform distribution of light in direction away from the total internal reflection portion.

It will be apparent that the L-shape of the total internal reflection unit means that light output by the light source that is not directed towards the total internal reflection portion (or refracted towards there by the refraction portion) is not received by the total internal reflection unit.

The L-shape can, for instance, be positioned in the corner of an area to be illuminated. This proposed approach increases the amount of light that is directed into the area to be illuminated from the corner, by using the total internal reflection unit to contain, within the area to be illuminated, light that would have otherwise escaped. Put another way, the provision and configuration of the total internal reflection portion reduces light bleed in directions away from a desired area to be illuminated. The proposed approach thereby provides greater illumination of an area to be illuminated as well as improved uniformity of light.

The first sub-section and the second sub-section may be substantially perpendicular to one another. For instance, the first sub-section and the second sub-section may make a right angle with respect to one another.

Preferably, the first sub-section and second sub-section meet at a corner location. This approach reduces the chance that light emitted by the light source, away from the refraction portion, will not enter the total internal reflection portion and be back-reflected towards a desired area to be illuminated.

In some examples, the lens unit is configured such that, on average, a height of each of the first and second sub-sections reduces with increasing distance from the corner location. This improves a smoothness or gradient of light output via the lens unit, reducing or mitigating any sudden cut-offs in the light beam output by the lens unit.

Preferably, the lens unit is formed of a uniform piece of material. This avoids or reduces unexpected redirecting (e.g., reflections/refractions) at any interfaces between the different portions of the lens unit, as well as increasing an ease and cost of manufacturing the lens unit.

Examples of suitable materials for use in forming the lens unit include plastics, such as polycarbonate or PMMA, or glass.

Preferably, the light source cavity has a height that is greater than a (maximum) height of the light source. This reduces a likelihood of mechanical coupling or interference between the lens unit and the light source.

The light source cavity may form part of a larger cavity of the lens unit, e.g., which may further include an optical cavity that receives light emitted by the light source (positioned in the light source cavity). A height of the light source cavity may be greater than a height of the light source. The height may be measured in a direction parallel to the axis.

There is also proposed a luminaire comprising any herein described lens unit; and a light source configured to generate light, wherein the light source is positioned to emit light into the lens unit.

In some examples, the light source is positioned to be partially surrounded by a volume bound by the L-shape formed by the first sub-section and the second sub-section of the total internal reflection portion of the lens unit. In particular, if present, the light source may be positioned inside the cavity of the lens unit.

There is also provided a lens plate comprising an array of lens units as herein/previously described. The lens plate may be formed of a uniform piece of material.

Preferably, the array of lens units are arranged in a regular grid. This approach improves a uniformity of light output via the lens plate.

The array of lens units preferably comprises no fewer than five lens units, e.g., no fewer than nine lens units.

There is also proposed a luminaire comprising any herein/previously described lens plate; and for each lens unit of the lens plate, a corresponding light source configured to generate light and positioned in the light source cavity of said lens unit and positioned to emit light into said lens unit. Thus, there may be as many light sources as there are lens units of the lens plate.

In some examples, for each lens unit the corresponding light source lies in a volume that is positioned to be partially surrounded by the L-shape formed by the first sub-section and the second sub-section of the total internal reflection portion of the lens unit. In particular, if present, the light source may be positioned inside the cavity of the lens unit.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates a lens unit;

FIG. 2 illustrates a portion of a luminaire comprising the lens unit in a cut-off view;

FIG. 3 illustrates a cross-sectional view of a cavity in the lens unit of the luminaire;

FIG. 4 illustrates a cross-sectional view of the luminaire;

FIG. 5 illustrates another cross-sectional view of a portion of the luminaire;

FIG. 6 illustrates a portion of the luminaire in a top-down, cut-off view;

FIG. 7 illustrates a lens plate and another luminaire; and

FIG. 8 illustrates the iso-illuminance plot for a luminaire without a total internal reflection portion and a luminaire with a total internal reflection portion.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a lens unit for directing light generated by a light source of a luminaire. The lens unit comprises a refraction portion and a total internal reflection portion. The total internal reflection portion is arranged in an L-shape.

The proposed approach is based on the realization that a total internal reflection portion can be used to direct light away from a corner through use of an L-shape. Thus, the proposed lens unit finds particular use in illuminating an environment from a corner of the environment. The proposed approach provides improved uniformity and illumination reach of a luminaire that makes use of the lens unit.

Embodiments can be employed in any suitable lighting environment in which it is desired to illuminate a region/area from a corner.

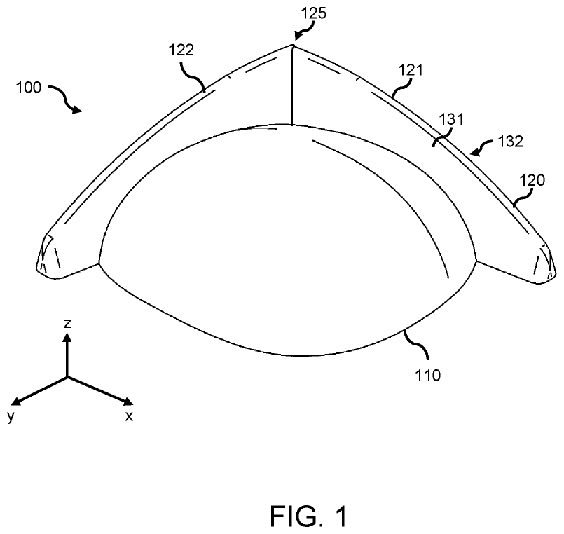

FIG. 1 illustrates a lens unit 100 for use in proposed embodiments. A light source for use with the lens unit lies in or on a plane x-y. In particular, the light source may be mounted to lie on the plane x-y, as will be later described.

The lens unit 100 is formed of a refraction portion 110 and a total internal reflection portion 120 (which can also be labelled a TIR portion). The lens unit 100 is preferably formed from one or more optically non-absorbent materials, i.e., any suitable material that absorbs less than 5%, e.g., less than 1%, of light incident thereon. Suitable examples include appropriately configured/designed plastics, such as polycarbonate or 20 PMMA, or glass.

In some examples, the lens unit is formed of a single uniform piece of material, e.g., a single piece of plastic or glass.

The total internal reflection portion 120 is formed of a first sub-section 121 and a second sub-section 122. The two sub-sections 121, 122 are positioned to form an L-shape when viewed along a direction z, which is perpendicular to the plane x-y. Conceptually, this means that, assuming the plane x-y is a horizontal plane, the total internal reflection portion 120 makes an L-shape or is L-shaped from viewed from above in a downward, vertical direction.

The L-shape means that the first and second sub-portions may be substantially perpendicular to one another, e.g., making an angle of 90°±5°, e.g., 90°±2°. In some preferred examples, the first and second sub-portions make a right angle (e.g., 90°±0.5°) with respect to one another. Put another way, the first and second sub-sections may be positioned to effectively form two sides of a square/oblong.

However, this is not essential. In some examples, the angle between the first and second sub-portions may greater, e.g., an angle of 90°±45°, e.g., 90°±30°, e.g., 90°±15°. This can allow for controlled design for different shaped/sized areas to be illuminated.

The total internal reflection portion 120 is arranged around (e.g., only two sides of) the refraction portion. Thus, the refraction portion 110 is positioned to lie such that it is effectively bounded by the two sub-sections of the total internal reflection portion. In particular, the total internal reflection portion 120 may bound or be located on the bounds of two sides of a volume in which the refraction portion 110 is positioned.

The refraction portion 110 may be surrounded by the total internal reflection portion 120 on only two sides. More generally, the refraction portion 110 may be surrounded by any element of the lens unit (including the total internal reflection portion 120) on only two sides.

Thus, at least two sides of the total internal reflection portion may be exposed. In other words, the lens unit may allow light emitted out from at least two sides of the refraction portion to escape the lens unit without intersecting the total internal reflection portion 120. In the illustrated example, the first and second sub-portions meet together at a corner location 125. Thus, the first and second sub-portions effectively abut one another.

In use, the corner location 125 may be positioned at a corner of an area to be illuminated by a luminaire comprising the lens unit, with the sub-sections of the total internal reflection portion being positioned along the bounds extending into the corner of the area to be illuminated.

The aim of the proposed lens unit 100 is to increase the amount of light emitted out of the lens unit in directions away from the total internal reflection portion (i.e., in use: away from the corner in which the lens unit is positioned).

In particular, if a light source is placed such that it is surrounded on two sides, and thereby partially surrounded, by the L-shape of the total internal reflection portion, then the proposed lens unit increases the amount of light that is emitted in directions parallel to directions originating at the light source and heading away from the total internal reflection portion. This provides a more effective mechanism for illuminating an environment from a corner of said environment (e.g., if the total internal reflection portion is positioned to face the corner.

The total internal reflection portion 120 also defines a first surface 131 and a second surface 132. The first surface 131 faces the refraction portion and the second surface faces away from the refraction portion. Thus, the first surface is more proximate to the refraction portion 110 than the second surface.

In use, the first surface 131 will face towards a region/environment for illumination and the second surface 132 will face away from the region/environment for illumination (e.g., towards a corner of the region to be illuminated). In particular, the lens unit provides (when a light source is positioned to be surrounded on two sides by the total internal reflection portion) for increased light intensity in directions parallel to directions away from the first surface 131 and reduced light intensity in directions parallel to directions towards the first surface 131.

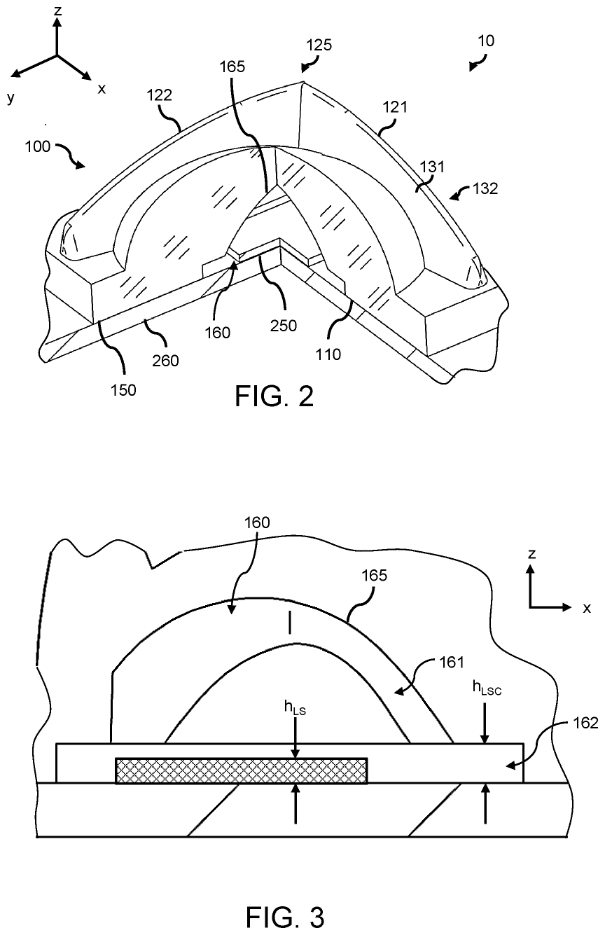

FIG. 2 illustrates a portion of a luminaire 10 comprising the lens unit 100.

The luminaire also comprises a light source 250. The light source comprises any suitable light emitting elements for generating and emitting light, such as an LED or an LED array, e.g., a surface mounted device LED arrangement or chip-on-board LED arrangement.

The light source 250 is positioned to lie underneath the refraction portion 110 within an area or volume bounded by the total internal reflection portion 120. In particular, the total internal reflection portion 120 may bound or be located on the bounds of two sides of a volume in which the light source is positioned.

The light source 250 is also positioned to lie underneath the total internal reflection portion, such that the total internal reflection portion does not intersect a plane on which the light source 250 lies. In other words, the total reflection portion is separated or distanced from the plane on which the light source lies 250.

More particularly, the light source 250 lies in a light source cavity 162. A plane in/on which the light source cavity 162 lies is distanced from the total internal reflection portion and the refraction portion. Put another way, the total international reflection portion does not intersect the plane on/in which the light source lies. Thus, the light source cavity 162 lies beneath the total internal reflection portion (as well as the refraction portion 110).

The luminaire 10 also comprises a mount 260 (e.g., a PCB). The mount 260 is configured to support the lens unit 100 and the light source 250. More particularly, the mount may lie in the plane x-y, being the plane on which the light source 250 is positioned. The z-direction lies perpendicular to the mount 260.

As illustrated in FIG. 2, the lens unit 100 may comprise a supporting portion 150 that supports the refraction portion 110 and the total internal reflection 120. The supporting portion may, for instance, be generally planar or have a rectangular cross-section. The supporting portion may define an upper surface lying in an upper surface plane. The refraction portion and the total internal reflection portion may effectively lie on this upper surface plane. More particularly, the total internal reflection portion may meet the supporting portion at the upper surface plane.

As illustrated in FIG. 2, the lens unit 100 comprises a recess, cavity, gap or space 160 in which the light source 250 is positioned. This provides a more compact luminaire, with reduced coupling between the light source 250 and the lens unit 100. The light source cavity 162 may form a part or portion of the cavity 160 in which the light source 250 is positioned.

The light source cavity 162 may be formed in the supporting portion 150 on which the refraction portion 110 and the total internal reflection portion 120 are positioned.

The cavity 160 is at least partially delimited by a light incidence surface 165, being a surface at which light emitted by the light source 250 is received by the lens unit 100. Light received at the light incidence surface is passed into the refraction portion 110 or the total internal reflection portion 120.

FIG. 3 provides a cross-sectional view of a portion of the luminaire 10 comprising the lens unit 100, which better illustrates the cavity 160.

As illustrated in FIG. 3, the cavity 160 may be conceptually divided into an (optional) optical cavity 161 and the light source cavity 162. The optical cavity 161 is configured to receive the light emitted by the light source 250. The light source cavity 162 is sized and/or shaped to receive or house the light source 250. The cross-sectional shape of the light source cavity, when viewed in the direction z (perpendicular to the plane x-y on which the light source is positioned) is larger than the cross-sectional shape of the optical cavity. This allows for increased flexibility in positioning of the light source, and for placement of powering, driving and/or control elements for the light source within the light source cavity 162, without influencing the optical performance of the lens unit.

The height h_{LSC} of the light source cavity 162 is preferably greater than the height h_{LS} of the light source 250. The height h_{LSC} of the light source cavity 162 can be alternatively labelled an avoidance gap. This approach helps avoid or reduce any mechanical interference between the light source 250 and the lens unit 100, particularly if the light source is subject to manufacturing tolerances that affect its height.

The heights may be defined as a dimension in a direction perpendicular to the plane x-y on which the light source is positioned, i.e., a dimension along the direction z.

In particular examples, the height h_{LSC} of the light source cavity 162 is no less than 5 mm, e.g., no less than 7 mm. This provides a good tolerance for fitting different types of light sources 250 without resulting in mechanical interference between the light source and the lens unit.

The precise shape of the light source cavity may depend upon the size and shape of the light source. The shape of the light source cavity may, for instance, be round, square or any other regular/irregular shape.

As previously mentioned, the light source 250 is positioned on a plane x-y. The refraction portion and the total internal reflection portion is distanced from this plane, e.g., so as to not intersect this first plane. Thus, a plane on which the light source lies or the light source cavity 162 lies, is distanced from the refraction portion and the total internal reflection portion, e.g., does not intersect either portion.

Put another way, the light source cavity 162 is located beneath or under the refraction portion 110 and the total internal reflection portion 125. In other words, the light source cavity 162 lies in a first plane and the refraction portion and total internal reflection portion lie in a different plane to the first plane.

The total internal reflection portion 120 is arranged around (two sides of) the refraction portion. Thus, the refraction portion 110 is positioned to lie such that it is effectively bounded by the two sub-sections of the refraction portion within an area or volume bounded by the total internal reflection portion. In particular, the total internal reflection portion 120 may bound or be located on the bounds of two sides of a volume in which the refraction portion 110 is positioned.

The optical cavity 161 may be omitted in some variations of the proposed approach.

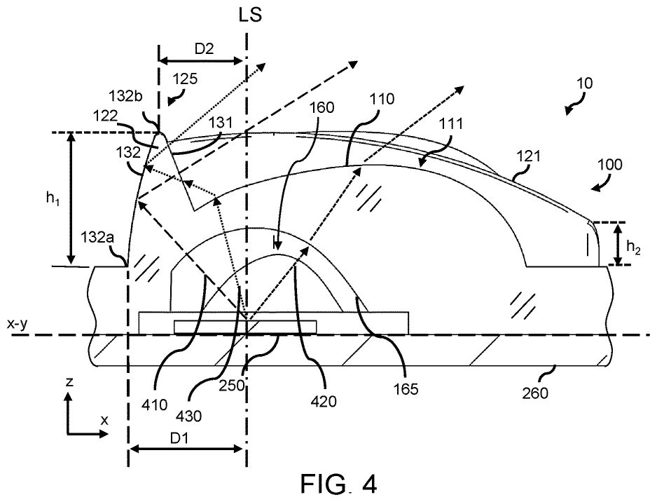

FIG. 4 provides a cross-sectional view of the luminaire 10 comprising the lens unit 100.

FIG. 4 helps illustrate the positional relationship between the light source cavity 162 of the lens unit, the refraction portion 110 and the total internal reflection portion 121, 122.

More particularly, FIG. 4 illustrates how the plane x-y, on which the light source (and therefore light source cavity 162) is positioned, is distanced from the total internal reflection portion 120 and the refraction portion 110. In this way, the refraction portion and the total internal reflection portion may be located closer to the light output surface of the lens unit than the light source cavity 162 (and therefore the light source 250).

Thus, if the light source or light source cavity 162 is considered to lie on a first plane x-y, then the total internal reflection portion will not intersect this first plane x-y.

FIG. 4 also illustrates, with dashed/dotted lines, the paths taken by different light rays 410, 420, 430 generated by the light source 250.

The total internal reflection portion 120 of the lens unit is configured to reflect, using total internal reflection (TIR), light received from the light source 250.

The principle of total internal reflection is well-established in the art, and has not been described in detail for the sake of conciseness. Generally, total internal reflection makes use of the interaction of light rays with the boundary between different materials (e.g., air and the material of the total internal reflection portion) having different refractive indices in order to reflect light.

This TIR effect of the total internal reflection portion 120 is perhaps best illustrated by the path taken by a first light ray 410, which is emitted by the light source 250 and into the total internal reflection portion 120. The first light ray 410 reflects (via total internal reflection) from the second surface 132 of the total internal reflection portion 120 before being transmitted through the first surface 131. In this way, the first ray is reflected by the total internal reflection portion 120 via total internal reflection.

It will be apparent that the proposed approach increases the amount of light that is emitted in directions parallel to directions originating at the light source 250 and heading away from the total internal reflection portion, i.e., in directions away from the first surface 131 of the total internal reflection portion 120. More particularly, the proposed approach increases the number of rays that are output from the first surface 131 of the total internal reflection portion (and thereby towards a desired region for illumination) compared to the number that are output from the second surface 132 (if such TIR surface 132 would not exist, and thereby away from the desired region for illumination).

The refraction portion 110 is configured to refract light received from the light source 250.

The illustrated refraction portion 110 is shaped as a dome with an off-center apex 111 or top. In particular, the apex or top of the dome is positioned to lie further away from the total internal reflection portion 120, e.g., compared to a dome with a central apex or top. This design helps to direct light received by the refraction portion 110 away from the total internal reflection portion, improving the light intensity and distribution in directions away from the first surface 131 of the total internal reflection portion 120.

The proposed system also reduces the average of the angles that rays emitted from the lens unit make with respect to the plane x-yon which the light source lies. This approach increases the amount of light that reaches locations in the external environment that are distant from the lens unit (i.e., before hitting a floor or ground surface).

FIG. 4 also illustrates a path taken by a second ray 420 that has been generated by the light source 250 in a direction away from the total internal reflection portion 120. The second ray 420 is received by the refraction portion 110 and directed further away from the total internal reflection portion 120.

FIG. 4 also illustrates a path taken by a third ray 430 that is emitted into the refraction portion 110. The third ray 430 is refracted towards the total internal reflection portion 120 and undergoes total internal reflection at the second surface 132 of the total internal reflection portion (i.e., to be redirected away through the first surface 131 of the total internal reflection portion).

The refraction portion 110 and the total internal reflection portion 120 are designed such that rays that are refracted towards the total internal reflection portion (by the refraction portion 110) undergo total internal reflection by the total internal reflection portion to reduce the number of rays that transmitted through the total internal reflection portion—i.e., increase the number of rays that are directed out of the first surface 131 of the total internal reflection portion (and thereby in directions away from the first surface 131 of the total internal reflection portion 120).

In this way, when in use, the lens unit decreases the number of rays that are output by the lens unit in directions out of the lens unit and away from the second surface, e.g., towards a corner in which the luminaire or lens unit is positioned. As previously explained, in use, the lens unit is positioned such that the second surface faces a corner of a region to be illuminated in which the luminaire is positioned.

In some examples, and as illustrated, wherein (on average) a height h₁, h₂ of each of the first 121 and second 122 sub-sections reduces with increasing distance from the corner location 125. This approach provides a smoother transition between light emitted in directions away from the first surface 131 of the total internal reflection portion and other light emitted by the luminaire 10.

As illustrated in FIG. 4, each sub-section may begin at a first height h₁ before reducing to a second, smaller height h₂ more distant from the corner location 125. The height may, for instance, follow a curve—such that the height initially increases before decreasing to the second height.

As illustrated in FIG. 4, the second surface 132 of the total internal reflection portion is sloped with respect to the plane x-y on which the light source is positioned. In particular, the second surface 132 may be considered to be angled or sloped towards the refraction portion 110, i.e., rather than being perpendicular thereto. This approach reduces the effective magnitude of the angle that a light ray reflected by the second surface 132 via TIR makes with respect to the plane x-y. This approach increases the amount of light that reaches locations in the external environment that are distant from the lens unit (i.e., before hitting a floor or ground surface). Sloping the second surface in this way thereby increases the illumination reach of a luminaire containing the lens unit 100.

More specifically, the second surface 132 comprises a proximal end 132a and a distal end 132b. The proximal end is positioned closer to the light source cavity 162 than the distal end 132b, i.e., closer to the plane x-y. In a sectional plane through the axis LS, a distance D1 between the proximal end 132a and the axis LS is larger than a distance D2 between the distal end 132b and the axis LS. In this way, the second surface is effectively sloped towards the refraction portion 110.

The proximal end 132a of the second surface 132 may meet the supporting portion 150 of the lens unit 100. In particular, the second surface 132 may terminate at the supporting portion 150 of the lens unit, wherein there is a significant angle (e.g., >20°) between the second surface 132 and an upper surface 151 of the supporting portion 150. The upper surface 151 of the supporting portion is also distanced from the plane x-y on which the light source is positioned. Put another way, a vertex exists at the meeting of the second surface 132 and the supporting portion 150 (at the proximal end 132a of the second surface 130), wherein an angle between the second surface and the supporting portion at the vertex is greater than 20°, e.g., greater than 60°.

In this way, the total internal reflection portion 120 appears to extend outwardly from the supporting portion 150 of the lens unit 100.

In some examples, the second surface 132 of the total internal reflection portion may be curved. The center of curvature of the second surface (if curved) is positioned on a same side of the second surface as the light source or refraction unit.

As illustrated in FIG. 4, the first surface 131 of the total internal reflection portion may also be sloped with respect to the plane in which the lens unit lies. In particular, the second surface may be angled or sloped away from the refraction portion 110. This reduces the angle between any rays reflected from the second surface 132 and arriving at the first surface 131, increasing the number of rays that escape the total internal reflection portion in directions away from the first surface (i.e., reducing the number of rays that are re-reflected by the first surface 131 via TIR).

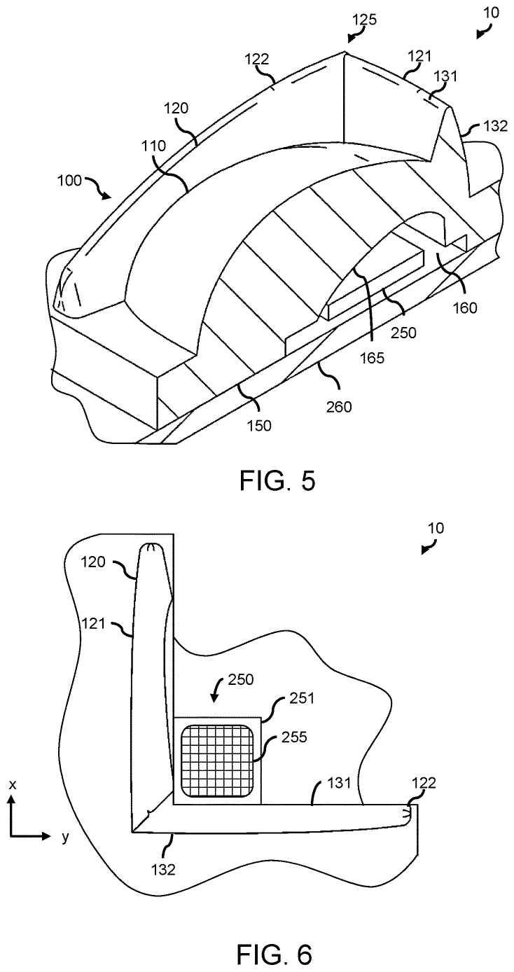

FIG. 5 provides another cross-sectional view of the portion of the luminaire 10, more clearly illustrating elements of the lens unit 100. FIG. 5 also provides a view of a proposed shape for the refraction portion, namely a dome with an off-center apex or top.

FIG. 6 provides a top-down, cut-off view of a portion of the luminaire 10. In particular, the refraction portion of the lens unit 100 is omitted from this illustration.

FIG. 6 helps illustrate a positional relationship between the lens unit 100 and the light source 250 according to an embodiment. In particular, the lens unit 100 and light source 250 may be positioned such that the light source is surrounded (e.g., on two sides) by a volume bound by the total internal reflection portion of the lens unit. More particularly, the light source may be partially surrounded by a volume bound by the L-shape formed by the first sub-section and the second sub-section of the total internal reflection portion of the lens.

FIG. 6 also illustrates how the light source 250 may be formed from a LED package 251 and a light emitting surface 255 on top of the LED package 251.

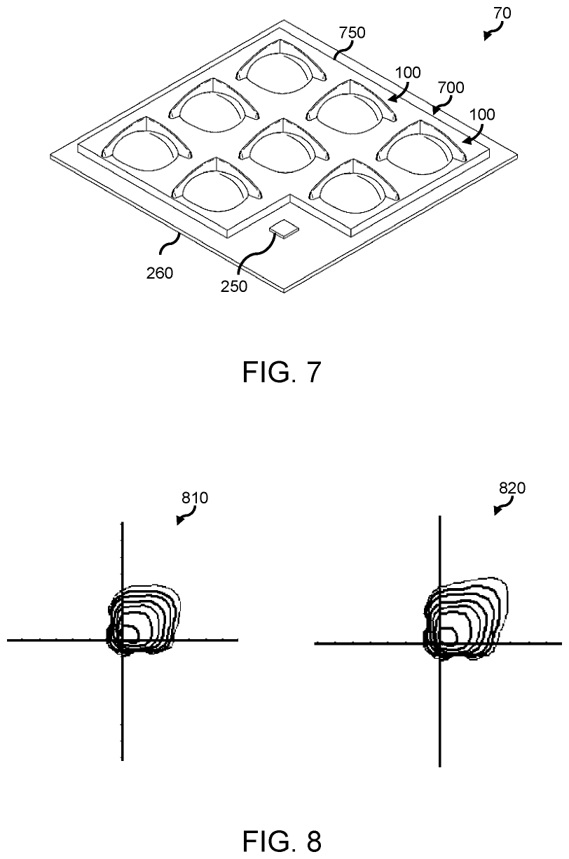

FIG. 7 illustrates a luminaire 70 comprising a lens plate 700 comprising an array (i.e., a plurality) of lens units 100 previously described. Each lens unit is mounted on a same lens plate mount 750.

The illustrated lens plate 700 is formed of a uniform piece of material. The array of lens units is arranged in a regular grid. However, other arrangements will be apparent to the skilled person, e.g. circularly arranged or pseudo-randomly arranged. A regular grid improves the uniformity of light output by the luminaire 70.

The array of lens units preferably comprises no fewer than five lens units, e.g., no fewer than nine lens units. In the illustrated example, the array of lens units comprise 9 lens units arranged in a regular 3×3 grid.

It will be appreciated that the luminaire 70 comprises, for each lens unit of the lens plate, a corresponding light source 250 configured to generate light and positioned to emit light into said lens unit. Thus, each lens unit 100 of the lens plate 700 has a corresponding light source. Suitable positional relationship between the lens unit and its corresponding light source have been previously described.

Of course, the luminaire may comprise a mounting plate 260 for mounting the lens plate 70 and light sources 250 thereon.

FIG. 8 illustrates the iso-illuminance plot 810 for a luminaire having a first lens plate comprising lens units without a total internal reflection portion.

FIG. 8 also illustrates the iso-illuminance plot 820 for a luminaire having a second lens plate comprising lens unit with a total internal reflection portion. The lens units of the first and second lens plates are otherwise identical.

In both plots 810, 820, the luminaire has been positioned at the origin, i.e., at a point (0,0). The first sub-section of the/each lens unit lies parallel to the y-axis and the second sub-section lies parallel to the x-axis. The first surface of the total internal reflection unit faces the first quadrant (i.e., the top right) of the plot.

FIG. 8 clearly demonstrates how there is an increased reach and uniformity of light output by the luminaire having the second lens plate compared to the luminaire having the first lens plate. Thus, the total internal reflection portion(s) provide improved uniformity and illumination capabilities for a luminaire.

TABLE 1

| Type | Light Output Ratio (%) |
|---|---|
| Baseline | 44 |
| No TIR portion | 49 |
| With TIR portion | 53 |

Table 1 illustrates one experimental measure of the improvement provided by using a lens unit having a total internal reflection portion. The light output ratio represents the percentage increase in light output in desired directions (i.e., away from a corner) for a luminaire.

The “baseline” type indicates a lens unit comprising a refraction portion (but no TIR portion), where the refraction portion is shaped as a dome with a centered apex or top (i.e., a non-skewed dome). The “No TIR portion” type indicates a lens comprising a refraction portion 110 (but no TIR portion 120), where the refraction portion is shaped as a dome with a non-centered apex or top, e.g., having the shape illustrated in the Figures. The “With TIR portion” type indicates a lens unit having the same refraction portion 110 as the “No TIR portion” type, but including the total internal reflection portion 120.

From Table 1, it is clear that there is a direct improvement in the light output ratio as a result of using a TIR portion 120.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A lens unit (100) for a luminaire comprising a light source having an axis (LS) perpendicular to a plane (x-y) onto which the light source is positioned, the lens unit comprising:
a light source cavity (162) into which the light source is positionable to receive light from the light source;
a refraction portion (110), distanced from the plane (x-y), for refracting light received from the light source; and
a total internal reflection portion (120), distanced from the plane (x-y), wherein the total internal reflection portion (120) comprises a first sub-section (121) and a second sub-section (122) that are angled with respect to one another so as to form an L-shape when viewed along a direction (z) normal to the plane (x-y);
wherein each of the first sub-section (121) and the second sub-section (122) of the total internal reflection portion (120) comprises a first surface (131) that faces towards the refraction portion (110) and a second surface (132) that faces away from the refraction portion (110), wherein the second surface (132) is sloped with respect to the plane (x-y) to reflect light received from the light source using total internal reflection;
wherein the second surface (132) comprises a proximal end (132a) and a distal end (132b), the proximal end (132a) being positioned close to the light source cavity (162) than the distal end (132b), and wherein in a sectional plane through the axis (LS), a distance (D1) between the proximal end (132a) and the axis (LS) is larger than a distance (D2) between the distal end (132b) and the axis (LS).

2. The lens unit (100) of claim 1, wherein the first sub-section (121) and the second sub-section (122) are substantially perpendicular to one another.

3. The lens unit (100) of claim 2, wherein the first sub-section (121) and the second sub-section (122) make a right angle with respect to one another.

4. The lens unit (100) of any of claims 1 to 3, wherein the first sub-section (121) and second sub-section (122) meet at a corner location (125).

5. The lens unit (100) of claim 4, wherein, on average, a height (h₁, h₂) of each of the first (121) and second (122) sub-sections reduces with increasing distance from the corner location (125).

6. The lens unit (100) of any of claims 1 to 5, wherein the lens unit is formed of a uniform piece of material.

7. A luminaire (10) comprising:
the lens unit (100) of any of claims 1 to 6; and
a light source (250) configured to generate light, wherein the light source is positioned to emit light into the lens unit.

8. The luminaire (10) of claim 7, wherein a height (h_{LSC}) of the light source cavity (162) is greater than a height (h_{LS}) of the light source (250).

9. The luminaire (10) of claim 7 or 8, wherein the light source is positioned to be partially surrounded by a volume bound by the L-shape formed by the first sub-section and the second sub-section of the total internal reflection portion of the lens unit.

10. A lens plate (600) comprising an array of lens units (100) according to any of claims 1 to 6.

11. The lens plate (600) of claim 10, wherein the lens plate is formed of a uniform piece of material.

12. A luminaire (60) comprising:
the lens plate (600) of any of claims 10 to 11; and
for each lens unit (100) of the lens plate, a corresponding light source (250) configured to generate light and positioned in the light source cavity of said lens unit and positioned to emit light into said lens unit.

13. The luminaire of claim 12, wherein, for each lens unit of the lens plate, the corresponding light source lies in a volume that is partially surrounded by the L-shape formed by the first sub-section and the second sub-section of the total internal reflection portion of the lens unit.
